(19) United States
(12) Patent Application Publication
(10) Pub. No.: US 2025/0059399 A1
(43) Pub. Date: Feb. 20, 2025

(54) POLYCARBONATE-BASED OPTICAL LAMINATE, MANUFACTURING METHOD THEREOF, AND COVER WINDOW USING THE SAME

(71) Applicant: GWANGJU INSTITUTE OF SCIENCE AND TECHNOLOGY, Gwangju (KR)

(72) Inventors: Hongkyu KANG, Gwangju (KR); Sangcho KIM, Gwangju (KR); Hyeon-Seok JEONG, Gwangju (KR)

(21) Appl. No.: 18/803,318

(22) Filed: Aug. 13, 2024

(30) Foreign Application Priority Data
Aug. 14, 2023 (KR) 10-2023-0106445

(51) Int. Cl. C09D 183/06; C08J 7/04; C08J 7/043; C09D 5/00; C09D 133/04; C09D 163/00; C09D 175/14; G02B 1/14

(52) U.S. Cl. CPC C09D 183/06; C08J 7/042; C08J 7/043; C09D 5/002; C09D 133/04; C09D 163/00; C09D 175/14; G02B 1/14; C08J 2369/00; C08J 2433/04; C08J 2463/00; C08J 2475/12; C08J 2483/06

(57) ABSTRACT

The present inventive concept relates to a transparent polycarbonate-based optical laminate, which satisfies both high surface hardness and impact resistance, making it applicable to curved designs, a manufacturing method thereof, and a cover window using the same. More specifically, the present inventive concept provides an optical laminate: including a polycarbonate/primer layer/hard coating layer, wherein (A) the hard coating layer is a cured product of a siloxane resin prepared by hydrolytic condensation of an alkoxy silane of the following Formula 1 containing a cycloaliphatic epoxy group; and (B) the primer layer is a cured product of a mixture of at least one curing resin selected from an acrylic-based resin, a polyurethane-based resin, and an epoxy-based resin, and the siloxane resin.

R¹Si(OR²)₃ [Formula 1]
where R¹ is a linear or branched C₁-C₆ alkyl group containing a cycloaliphatic epoxy group, the cycloaliphatic epoxy group being a C₃-C₆ cycloalkyl group that forms a fused bicycle with an epoxy group, and R² is a linear or branched C₁-C₆ alkyl group.

### CROSS-REFERENCE TO RELATED PATENT APPLICATION

This application claims the benefit of Korean Patent Application No. 10-2023-0106445, filed on Aug. 14, 2023, in the Korean Intellectual Property Office, the disclosure of which is incorporated herein in its entirety by reference.

### BACKGROUND OF THE INVENTIVE CONCEPT

### 1. Field of the Inventive Concept

The present inventive concept relates to a transparent polycarbonate-based optical laminate, which satisfies both high surface hardness and impact resistance, making it applicable to curved designs, a manufacturing method thereof, and a cover window using the same.

### 2. Description of the Related Art

A display device comprises a display panel provided with a plurality of pixels for displaying an image and a cover window formed on the display panel to protect the display panel from external shock or contamination. Basically, the properties required for the cover window include surface hardness to prevent scratches on the surface, impact resistance to prevent damage from external impacts, and optical properties to prevent damage or distortion to the displayed image. Depending on the specific application of the display, additional properties are required. For example, cover windows applied to flexible displays require flexibility with a curvature radius of sub-millimeter, while displays used for outdoor advertising require weather resistance to direct sunlight and high humidity.

The increase in the vehicle's interior space due to the transition from internal combustion engines to electric batteries and the implementation of autonomous driving systems have transformed the vehicles from simple means of transportation into dynamic living and entertainment spaces, bringing about significant changes in the role of vehicles. The displays in vehicles, which were previously limited to navigation, have seen a significant increase in their role in displaying vehicle status information related to the expansion of infotainment services driven by the advancement of smart devices and networks as well as the digitization and electrification of vehicles. As vehicle interiors expand and driver behaviors evolve, automotive manufacturers are turning their focus to next-generation touch displays to improve the in-vehicle user experience. This concept known as “in-vehicle infotainment” includes features such as instrument clusters, head-up displays (HUDs), central information displays (CIDs), e-mirrors that replace rearview or side mirrors, entertainment displays for the front or rear seat, etc. These displays can be integrated into steering wheels, dashboards, center consoles, side panels, and seats. The enlargement, high-resolution enhancement, and adoption of curved or irregular-shaped displays can provide interfaces within vehicles that allow a closer interaction between the vehicle and its occupants.

The display applied to vehicles requires more durability to withstand passengers' various and frequent physical impacts, and they should have excellent formability to be shaped into various forms, unlike conventional navigation-type central information displays. Cover windows made of tempered glass are widely used as reliable protective devices for displays due to their high surface hardness, providing excellent scratch and abrasion resistance. However, due to the inherent rigidity and brittleness of glass, it has low impact resistance and tendency to shatter upon impact, posing a threat to the safety of passengers and drivers in the event of an accident. Moreover, when the glass is formed into curved or irregular shapes, there are difficulties in maintaining optical properties without distortion. To overcome these limitations of traditional glass materials, there is a demand for the development of new cover window materials that combine the desirable properties of glass, such as high transparency and surface hardness, with high impact strength.

In recent years, research on implementing cover windows with plastic materials has been extensively conducted to address the issues with tempered glass materials. Representative examples of transparent and flexible plastics include poly(methyl methacrylate) (PMMA), poly(ethylene terephthalate) (PET), and polycarbonate (PC). These plastics are emerging as viable alternatives to glass in various applications such as optical lenses, solar panels, safety windows, automotive glass, etc. Plastic materials have the advantages such as ease of processing, low manufacturing costs, and compliance with the lightweight requirements demanded by eco-friendly vehicles. Among others, polycarbonate has an optical transparency comparable to glass and an impact strength 250 times higher than glass and 50 times higher than commonly used PMMA. Due to these properties, polycarbonate is widely used as a substitute for laminated glass in various applications. This strength makes it an ideal choice for preventing casualties that may result from damage due to external impacts such as accidents. However, despite its excellent optical and mechanical properties, polycarbonate is not suitable for use as cover windows for displays due to its low surface hardness, which makes it vulnerable to scratching and abrasion due to frequent physical contact with passengers and drivers.

To address these issues, various research results have been reported on the formation of functional coating layers to improve physical properties such as transmittance, contact angle, and surface hardness while preserving the inherent properties of polycarbonate substrates. However, many physical properties are known to have a trade-off relationship, meaning that improving one property may lead to the deterioration of other associated properties. Typically, the impact resistance and surface hardness (scratch resistance) exhibit a typical trade-off relationship, where improving the surface hardness may weaken the impact resistance as well as flexibility, making it difficult to create curved shapes. Simultaneously improving different physical properties is not only challenging but can also lead to additional issues such as low adhesion associated with the formation of functional layers, deterioration of optical properties due to interfacial reflection and/or refraction, etc. Therefore, achieving both high surface hardness and strong impact strength is a crucial challenge for the commercialization of cover windows for displays, especially cover windows for automotive displays, made of polycarbonate as a substitute for glass.

Hard coating layers made of cycloaliphatic epoxy-functionalized siloxane (CEOS) are mainly composed of ladder-structured silsesquioxane and are known to partially contain cage-structured silsesquioxane (Adv. Mater. 2017, 29, 1700205). It is known that CEOS coated onto a substrate such as glass, polyethylene terephthalate (PET), or colorless polyimide (CPI) forms a hybrid layer via crosslinking on the substrate surface, resulting in a significant increase in the surface hardness. However, there has been limited research conducted on the use of polycarbonate substrates with low surface hardness. The present inventors have found that when forming a hard coating layer using CEOS on a polycarbonate substrate, the adhesion between the substrate and the hard coating layer is low, resulting in the deterioration of impact resistance and durability. Accordingly, the present inventors have made an effort to find a solution to this issue, thereby completing the present inventive concept.

### SUMMARY OF THE INVENTIVE CONCEPT

The present inventive concept has been made in an effort to solve the above-described problems associated with prior art, and an object of the present inventive concept is to provide an optical laminate that has a high surface hardness while maintaining the impact resistance of a polycarbonate substrate, and a manufacturing method thereof.

Another object of the present inventive concept is to provide a primer composition for use in the preparation of the optical laminate.

Still another object of the present inventive concept is to provide a cover window for a display using the optical laminate.

The above-mentioned objects of the present inventive concept will be clearly understood by those skilled in the art from the following detailed description. Moreover, in describing the inventive concept, when it is determined that the detailed description of the known technology related to the inventive concept may unnecessarily obscure the gist of the inventive concept, the detailed description thereof will be omitted.

To achieve the above-mentioned object, the present inventive concept provides an optical laminate: comprising a polycarbonate/primer layer/hard coating layer, wherein (A) the hard coating layer is a cured product of a siloxane resin prepared by hydrolytic condensation of an alkoxy silane of the following Formula 1 containing a cycloaliphatic epoxy group; and (B) the primer layer is a cured product of a mixture of at least one curing resin selected from an acrylic-based resin, a polyurethane-based resin, and an epoxy-based resin, and the siloxane resin.

R¹Si(OR²)₃ [Formula 1]
where R¹ is a linear or branched C₁-C₆ alkyl group containing a cycloaliphatic epoxy group, the cycloaliphatic epoxy group being a C₃-C₆ cycloalkyl group that forms a fused bicycle with an epoxy group, and R² is a linear or branched C₁-C₆ alkyl group.

The hard coating layer prepared by the hydrolytic condensation of the alkoxy silane of Formula 1 containing a cycloaliphatic epoxy group is an organic-inorganic composite, which forms a hybrid layer that has flexibility due to the structure derived from a cycloaliphatic epoxy alkyl group, which is an organic group, and high hardness due to the siloxane structure, which is an inorganic group. The main siloxane structure is ladder-like silsesquioxane, and is also known to have cage-structured and partial cage-structured silsesquioxanes. Since it is known that the hard coating layer can be formed on a substrate such as PET, CPI, or glass to prepare a laminate with high hardness, flexibility, and high impact strength, it was expected that the formation of a hard coating layer on a polycarbonate substrate will make it possible to address the issue of low surface hardness of polycarbonate. However, a PC/HC laminate hard-coated with the siloxane resin containing a cycloaliphatic epoxy group had significantly improved the surface hardness, but this improvement was accompanied by a significantly decrease in impact strength, from 50 J to 7.5 J, making it unsuitable for use as an optical laminate. For a PC/PR/HC laminate, in which a primer layer (PR) derived from an epoxy resin, typically used as a primer, was interposed between the polycarbonate substrate and the hard coating layer, it was possible to maintain a pencil hardness level of 5H while increasing the impact strength to a level of 41. However, due to the deterioration in durability caused by low adhesion, it was deemed unsuitable for use as an actual optical laminate. The decrease in adhesion is attributed to the low degree of bonding between the primer layer and the hard coating layer, and it is presumed to have affected the decrease in surface hardness of the laminate as well.

The present inventive concept is intended to solve the aforementioned problems, and the optical laminate comprising a polycarbonate/primer layer/hard coating layer according to the present inventive concept is characterized in that the hard coating layer is a cured product of a siloxane resin containing a cycloaliphatic epoxy group, and the primer layer is a cured product of a mixture of at least one curing resin selected from an acrylic-based resin, a polyurethane-based resin, and an epoxy-based resin, and the siloxane resin. In the above configuration, the primer layer acts as a barrier to prevent the incorporation of inorganic particles constituting the hard coating layer into a polycarbonate layer, which has a low chemical resistance, during the hard coating process, thus maintaining the inherent impact resistance of polycarbonate. The primer layer and the hard coating layer chemically bond at an interface to demonstrate excellent surface hardness along with high adhesion. Furthermore, the formation of the primer layer with a mixture of a hard coating agent makes it possible to reduce the interlayer refraction or reflection caused by the primer layer, which suppresses the increase in haze value, resulting in a laminate with excellent optical properties. With the structural properties as described above, the laminate of the present inventive concept can be effectively used as an optical laminate, as it significantly improves the surface hardness, which is the main disadvantage of polycarbonate, while maintaining excellent impact strength and optical properties. Even when using a siloxane resin, which does not contain the cycloaliphatic epoxy group, as the siloxane resin that constitutes the hard coating layer and the primer layer, the laminated structure formed by curing a mixture of at least one curing resin selected from an acrylic-based resin, a polyurethane-based resin, and an epoxy-based resin, which constitute the primer layer, and the siloxane resin, which constitutes the hard coating layer, also exhibited enhanced adhesion and increased surface hardness. However, it was difficult to obtain a high-hardness laminate with a pencil hardness of 4H or more (data not shown). The curable resin comprises an acrylic-based resin, which is a radical polymerization resin, a polyurethane-based resin, and/or an epoxy-based resin, which is a cationic polymerization resin. The acrylic-based resin has an acrylate functional group, and examples thereof may include an acrylic resin, an epoxy acrylic resin, a polyurethane acrylic resin, and a polyether acrylic resin. The polyurethane-based resin is a compound that has a urethane bond within the molecule and may contain a functional group for photocuring, like the polyurethane acrylic resin. The epoxy-based resin has an epoxy functional group and may include a cycloaliphatic epoxy resin, a glycidyl ether-based epoxy resin, and an epoxy acrylate resin.

In the present inventive concept, the siloxane resin may be, for example, a siloxane resin where R¹ of the alkoxy silane of Formula 1 is a 2-(3,4-epoxycyclohexyl)ethyl group or a 2-(3,4-epoxy-3-methylcyclohexyl)ethyl group. Since R² is removed in the form of alcohol during the condensation reaction, it does not affect the properties of the hard coating layer. The hydrolytic condensation of alkoxy silanes is widely known in the art, and thus the detailed description thereof will be omitted.

The optical laminate according to the present inventive concept exhibits excellent optical properties, with an average transmittance of 90% or more in the range of 380 to 780 nm and a haze of less than 1%. Moreover, the optical laminate of the present inventive concept overcomes the troublesome trade-off between scratch resistance and impact resistance, exhibiting a pencil hardness of 5H-7H on the hard coating surface and a dart drop impact strength of 20-50 J according to ASTM D3763, resulting in both excellent scratch resistance and impact resistance, as well as excellent adhesion with a rating of 5B in the cross-cut adhesion test. The radius of curvature indicating flexibility ranges from 10 mm to 25 mm, making it applicable to curved or irregular shapes. In addition, it exhibits excellent UV resistance, with a difference in yellowness of 0.30 or less after 18 hours of exposure to a 20W UV-B lamp positioned 20 cm away, making it useful for outdoor applications as well.

In the optical laminate of the present inventive concept, the thickness of the polycarbonate substrate can be appropriately adjusted depending on the intended use of the optical laminate, ranging from 1 μm to 5 mm, preferably from 10 μm to 1.2 mm, and more preferably from 100 μm to 1 mm, for example. The thickness of the primer layer may range from 1 μm to 50 μm, preferably from 2 μm to 20 μm. If the thickness of the primer layer is too thin, it may not provide sufficient protection to the polycarbonate substrate, leading to reduced impact resistance. The primer layer should be thick enough to prevent the introduction of inorganic substances that form the hard coating layer into the polycarbonate substrate, but it does not need to be excessively thick. The hard coating layer may be formed with a thickness ranging from 1 μm to 100 μm, preferably from 2 to 40 μm. If the thickness of the hard coating layer is too thin, the effect of improving surface hardness may be limited.

The present inventive concept also relates to a method of preparing the optical laminate as described above. More specifically, the method of manufacturing the optical laminate may comprise the steps of: (A) preparing a polycarbonate substrate, a siloxane resin prepared by the hydrolytic condensation of the alkoxy silane of the above Formula 1 containing a cycloaliphatic epoxy group, and a curing resin selected from an acrylic-based resin, a polyurethane-based resin, and an epoxy-based resin, respectively; (B) preparing a primer composition by mixing the siloxane resin and the curable resin at a predetermined ratio; (C) forming a primer layer by coating the primer composition onto the polycarbonate substrate, followed by curing; and (D) forming a hard coating layer by coating the hydrolyzed condensate of the alkoxy silane onto the primer layer, followed by curing.

The step (A) involves the preparation of the polycarbonate substrate and the respective compositions required for the manufacturing of the optical laminate. The polycarbonate substrate may undergo a cleaning step or a surface activation step such as plasma or ozone treatment before forming the primer layer. The siloxane resin may be prepared by hydrolytic condensation of alkoxy silane under normal acidic or alkaline conditions. The curable resin may comprise an acrylic-based resin, which is a radical polymerization resin, and/or an epoxy-based resin, which is a cationic polymerization resin, or a polyurethane-based resin. Specifically, the curable resin may comprise at least one selected from the group consisting of an acrylic resin, an epoxy acrylic resin, a polyurethane acrylic resin, a polyether acrylic resin, a cycloaliphatic epoxy resin, and a glycidyl ether-based epoxy resin. The siloxane resin and/or curable resin may be prepared in the form of a solution dissolved in an appropriate solvent to allow for mixing with the hydrolyzed condensate of the alkoxy silane when preparing the primer composition in the following step.

The step (B) involves the preparation of the primer composition by mixing the siloxane resin and the curable resin prepared in step (A). It is natural that the primer composition prepared in this step should be a homogeneous mixture without any precipitates or suspended matters. Since the properties of the manufactured optical laminate are determined depending on the mixing ratio of the hydrolyzed condensate of the alkoxy silane and the epoxy resin contained in the primer composition, the mixing ratio is determined based on the properties required for the optical laminate to be used later. The optical laminate manufactured by the method of the present inventive concept is excellent in both surface hardness and impact strength, but the higher the content of the curable resin, the higher the impact strength, and the higher the content of the siloxane resin, the higher the surface hardness. Therefore, the ratio can be appropriately selected by those skilled in the art depending on the intended use. For example, the siloxane resin and the curable resin may be mixed at a weight ratio of 20:80 to 80:20.

The step (C) involves the formation of the primer layer by coating the primer composition onto the polycarbonate substrate, followed by curing. The primer composition may be coated by any method used for coating optical laminates, such as bar coating and spin coating, without limitation. In this step, the viscosity of the primer composition can be controlled to facilitate processability, and the primer composition can be diluted with an organic solvent and coated to adjust the thickness of the coating film. The amount of organic solvent added is not particularly limited, but may range from 1 to 100 parts by weight per 100 parts by weight of the primer composition. [The solvents used for dilution may include at least one selected from the group consisting of ketones such as acetone, methyl ethyl ketone, methyl butyl ketone, methyl isobutyl ketone, cyclohexanone, etc. celluloses such as methyl cellosolve, ethyl cellosolve, cellosolve acetate, butyl cellosolve, etc. ethers such as ethyl ether, dioxane, tetrahydrofuran, etc., esters such as methyl acetate, ethyl acetate, propyl acetate, isopropyl acetate, butyl acetate, isobutyl acetate, pentyl acetate, isopentyl acetate, etc., alcohols such as butanol, 2-butanol, isobutyl alcohol, isopropyl alcohol, etc., halogenated hydrocarbons such as dichlorobenzene, dichloromethane, chloroform, dichloroethane, trichloroethane, tetrachloroethane, dichloroethylene, trichloroethylene, tetrachloroethylene, chlorobenzene, ortho-dichlorobenzene, etc., or hydrocarbons such as n-hexane, cyclohexanol, methylcyclohexanol, benzene, toluene, xylene, etc., but are not limited thereto.

Additionally, it is natural to include a polymerization initiator to facilitate the curing of the primer layer as needed. Any catalyst known in the art that can initiate the polymerization may be used as the initiator, and it would be easy for those skilled in the art to select and use an appropriate initiator depending on the type of curable resin used. For example, if the curable resin is one that is polymerized by radical polymerization, initiators such as benzoin ethers or amines can be used, and if the curable resin is one that is polymerized by cationic polymerization, initiators such as diazonium salts, iodonium salts, sulfonium salts alcohol, organometallic salts, etc. may be used, but are not limited thereto.

It is desirable that the formation of the primer layer is achieved by photocuring the primer composition. Photocuring forms a cured product by the polymerization of the cycloaliphatic epoxy group contained in the curable resin and the primer composition, creating a stable layered structure, while allowing some of the epoxy groups to remain unreacted, so that interfacial chemical bonds are formed through an additional ring-opening reaction with a hard coating composition during the formation of the hard coating layer, resulting in excellent adhesion.

The step (D) involves the formation of the hard coating layer by coating the hydrolyzed condensate of the alkoxy silane, which is a hard coating composition, onto the primer layer, followed by curing. Similar to step (C), in this step, the viscosity of the composition can be controlled to facilitate processability, and the hard coating composition can be diluted with an organic solvent and coated to adjust the thickness of the coating film. The solvent used may be the same as the organic solvent used for the formation of the primer layer or may be another solvent selected from the same group. It is also natural to include a polymerization initiator and/or catalyst to facilitate the curing of the hard coating layer as needed. Since the present inventive concept characterized by the primer composition and the hard coating of the siloxane resin containing a cycloaliphatic epoxy group using the polymerization initiator/catalyst can be performed by any method known in the prior art, and thus the detailed description thereof will be omitted. Moreover, it is more desirable that the formation of the hard coating layer in this step includes the steps of (a) photocuring the hydrolyzed condensate of the alkoxy silane; and (b) heat-treating the photocured product under a relative humidity condition of 50% or more. The heat-moisture treatment performed in step (b) not only significantly reduces the process time, but also increases the crosslinking density, resulting in excellent flexibility along with high surface hardness. If the primer composition and/or the hard coating composition contain(s) an organic solvent, a step of removing the solvent by heat treatment may be further performed before the photocuring the primer composition and/or the hard coating composition. The heat treatment is preferably performed at 30 to 150° C., more preferably at 40 to 100° C., and a vacuum condition may be created to lower the solvent removal temperature or increase the removal rate.

The present inventive concept also relates to a primer composition comprising a mixture of at least one curable resin selected from an acrylic-based resin, a polyurethane-based resin, and an epoxy-based resin, and a siloxane resin prepared by the hydrolytic condensation of the alkoxy silane of the above Formula 1. The primer composition can be used for purposes such as manufacturing optical laminates using polycarbonate substrates as described in the present inventive concept. In addition, it can be used for the formation of primer layers interposed between the substrate and the coating layer to enhance the adhesion between the substrate and the coating layer.

Another aspect of the present inventive concept relates to a cover window for a display comprising the optical laminate. The cover window for a display of the present inventive concept achieves high surface hardness and impact strength properties at the same time while also possessing excellent optical properties, flexibility, and light resistance, and thus it can be effectively used as a substitute for conventional cover windows for displays made of glass materials. In particular, as it is easy to process into various forms such as curved or irregular shapes, ensures the safety of passengers, and possesses excellent weather resistance, it is a promising material for display cover windows used in automobile displays that are evolving into various forms. It is natural that additional functional layers may be formed on the display cover window of the present inventive concept as needed.

As described above, as the introduction of a new primer composition between the polycarbonate substrate and the hard coating layer has solved the notorious trade-off issue between surface hardness and impact strength properties, the optical laminate of the present inventive concept achieves high surface hardness and impact strength properties at the same time, while also offering flexibility to design curved panoramic shapes, and thus can be effectively used as a cover window for a display. Especially, it can provide clear visual information due to its optical properties including high transmittance and low haze, and it is more suitable for use as a cover window for an automotive display as it improves the UV stability, which is a weakness of polycarbonate substrates.

### BRIEF DESCRIPTION OF THE DRAWINGS

The above and other features and advantages of the present inventive concept will become more apparent by describing in detail exemplary embodiments thereof with reference to the attached drawings in which:

FIG. 1 illustrates a method of forming a laminate according to an embodiment of the present inventive concept;

FIG. 2(a) and FIG. 2(b) depicts images and a graph showing the surface hardness and impact strength of the laminate according to an embodiment of the present inventive concept;

FIG. 3 is a conceptual diagram illustrating the decrease in impact strength of the laminate due to hard coating;

FIG. 4(a) and FIG. 4(b) depicts cross-cut adhesion test result images and FTIR spectra of the laminate according to an embodiment of the present inventive concept;

FIG. 5 is a conceptual diagram illustrating the decrease in adhesion and surface hardness of the laminate due to the low reactivity of the DGEBA and the hard coating layer;

FIG. 6(a), FIG. 6(b) and FIG. 6(c) depicts FTIR and cross-cut adhesion test result images showing the increase in adhesion of PC/MFP/HC by the MFP primer layer;

FIG. 7 depicts cross-cut adhesion test result images showing the difference in adhesion according to the primer layer forming process;

FIG. 8(a), FIG. 8(b) and FIG. 8(c) depicts graphs and an image showing the surface hardness of the PC/MFP/HC laminate depending on the CEOS ratio in the MFP composition;

FIG. 9(a), FIG. 9(b) and FIG. 9(c) depicts graphs and an image showing the surface strength of the PC/MFP/HC laminate depending on the CEOS ratio in the MFP composition;

FIG. 10 is a conceptual diagram illustrating the structure of the laminate of the present inventive concept; and

FIG. 11(a), FIG. 11(b), FIG. 11(c) and FIG. 11(d) depicts graphs showing the properties of the laminate according to an embodiment of the present inventive concept.

### DETAILED DESCRIPTION OF THE INVENTIVE CONCEPT

Hereinafter, the present inventive concept will be described in more detail with reference to the accompanying drawings and examples. However, these drawings and examples are provided merely as illustrations to facilitate the description of the technical idea and scope of the present inventive concept, and the technical scope of the present inventive concept is not limited or changed thereby. Based on these illustrations, it will be obvious to those skilled in the art that various modifications and changes are possible within the technical idea of the present inventive concept.

### EXAMPLES

### Example 1: Preparation of Primer Composition

CEOS was synthesized via a hydrolytic sol-gel reaction using a conventional alkaline catalyst, as described in Adv. Mater. 2017, 29, 1700205. Specifically, 0.1 mol of ECTMS (2-(3,4-epoxycyclohexyl)ethyltrimethoxysilane, Sigma-Aldrich), 0.15 mol of purified water, and 16 μl of ammonium hydroxide were placed in a flask and stirred at 80° C. for 5 hours. The hard coating composition was prepared by mixing 2 parts by weight of aryl sulfonium hexafluoroantimonate salt (TSHFA) as a polymerization initiator and 50 parts by weight of methyl ethyl ketone as a solvent per 100 parts by weight of the prepared epoxy siloxane resin.

The primer, DGEBA (bisphenol A diglycidyl ether, Sigma-Aldrich), was dissolved in 2 times (w/v) tetrahydrofuran (THF), and the curing agent, 4,4′-diaminodiphenyl sulfone (DDS), was added to the DGEBA:DDS at a molar ratio of 3:1 to prepare the coating composition.

The primer coating composition used for the formation of the primer layer according to the present inventive concept was prepared by adding the CEOS coating composition and the DGEBA coating composition, prepared as described above, in a ratio of 20-80% (w/w), and the resulting composition was named MFP-XX, where XX represents the weight percent (w %) of CEOS in the composition. For example, MFP-80 refers to a primer composition prepared by mixing CEOS 80:DGEBA 20 (w/w).

### Example 2: Coating of Polycarbonate Substrate

First, a commercial polycarbonate substrate (from I-Component Co., Ltd.) was treated with ozone to activate the surface. Subsequently, the MFP or DGEBA coating composition prepared in Example 1 was used to bar-coat the substrate with a thickness of 10 μm, and the solvent was evaporated by annealing at 80° C. for 1 hour. The resulting sample was then irradiated with UV light for 60 seconds using a metal halide lamp to form the primer layer.

Onto the substrate with the primer layer formed, the CEOS solution prepared in Example 1 was bar-coated to a thickness of 30 μm, and the solvent was evaporated by annealing at 80° C. for 1 hour. The resulting sample was then irradiated with UV light for 60 seconds using a metal halide lamp, followed by annealing at 85° C. and 85% relative humidity (RH) for 2 hours form the CEOS hard coating layer.

The laminate composed of a PC/CEOS hard coating layer was manufactured in the same manner as described above, with the exception of omitting the formation of the primer layer.

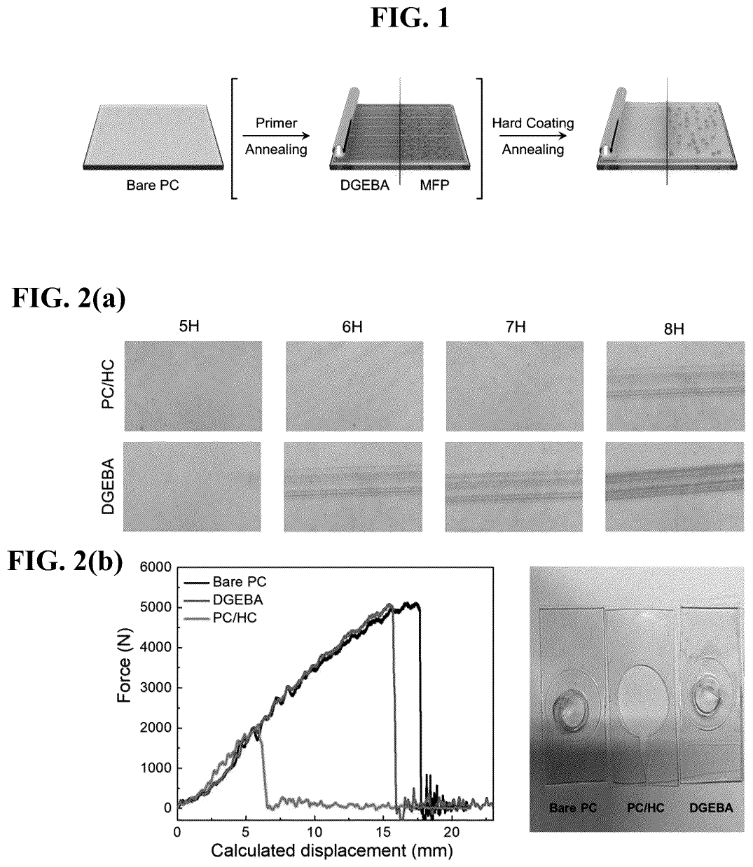

FIG. 1 illustrates a method of forming a laminate according to this embodiment.

### Example 3: Properties of Polycarbonate Laminate

### (1) PC/CEOS Hard Coating Laminate (PC/HC)

The properties of the PC/CEOS hard coating laminate prepared in Example 2 were evaluated using a prior art method. The surface hardness, indicative of scratch resistance, was measured by a pencil hardness test to determine the changes in mechanical strength due to the formation of the hard coating layer, and impact strength, indicative of impact resistance, was measured by a puncture test.

The pencil hardness was measured on the surface, where the hard coating layer was formed, using pencils with hardness ranging from 9B to 9H according to the ASTM (American Society for Testing and Materials) D3363 protocol. Prior to the test, the pointed part of the pencil was flattened and smoothed. The test was conducted at a 45° angle, with a weight of 750 g, from high to low hardness according to the protocol, and scratches were initially checked with the naked eye and inspected again under an optical microscope. The puncture test was conducted using a drop tower impact tester (CEAST 8350, Instron, Norwood, MA, USA) according to the ASTM D3763 protocol. The specimens, sized at 100 mm×100 mm, were fixed with a 100 N force onto a ring-shaped clamp with a diameter of 40 mm. The drop weight was released at a velocity of 4.83 m/s, corresponding to an impact energy of 60 J. The absorbed impact energy by the specimen was calculated by collecting data from the photonic sensor until the drop weight penetrated the surface at the first impact point on the specimen.

FIG. 2(a) and FIG. 2(b) depicts images and a graph showing the surface hardness and impact strength of the laminate according to this Example. As can be seen from FIG. 2(a) and FIG. 2(b), the pencil hardness of the polycarbonate substrate used in the test was only 4B; however, with the introduction of the hard coating layer, it significantly increased to 7H. On the contrary, while the impact strength of the polycarbonate substrate itself was 50 J, the impact strength of the laminate decreased significantly to 7.4 J.

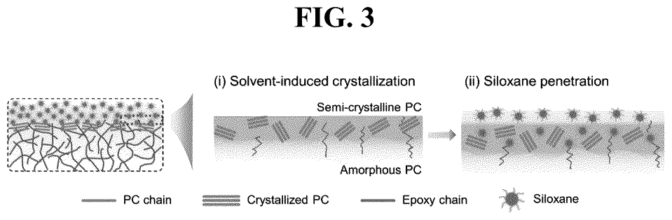

Polycarbonate is known for its low chemical resistance. Therefore, it was determined whether the solvent contained in the CEOS coating solution affects the impact resistance. To this end, a mixed solution excluding ECTMS from the solution for the preparation of CEOS in Example 1 was prepared and applied to the polycarbonate substrate. After annealing at 80° C. for 1 hour to evaporate the solvent, the impact strength was measured. As a result, it was observed that the solvent treatment alone led to the formation of cracks on the surface, resulting in a significant decrease in impact strength to 30 J (not shown). From this, it can be interpreted that the surface of the substrate is partially dissolved by the solvent, causing crystallization, and during the hard coating process, the siloxane particles constituting the hard coating layer penetrated into the interior of the substrate surface, exacerbating the formation of cracks and the reduction in impact strength. (See FIG. 3).

### (2) PC/DGEBA/HC Laminate

With the use of a primer during the formation of the PC/HC laminate, the primer layer acts as a barrier to prevent the introduction of siloxane particles into the interior of the polycarbonate substrate. Therefore, the PC/primer/HC laminates were formed and their properties were evaluated. DGEBA was selected as the primer, which is widely used in the construction of multilayer laminates due to its excellent adhesion to various substrates and chemical resistance to most solvents.

As can be seen from FIG. 2(a) and FIG. 2(b), the formation of the DGEBA primer layer significantly increased the impact strength of the laminate from 7.8 J to 41 J, demonstrating the effectiveness of the above-mentioned strategy; however, the pencil hardness decreased from 7H to 5H.

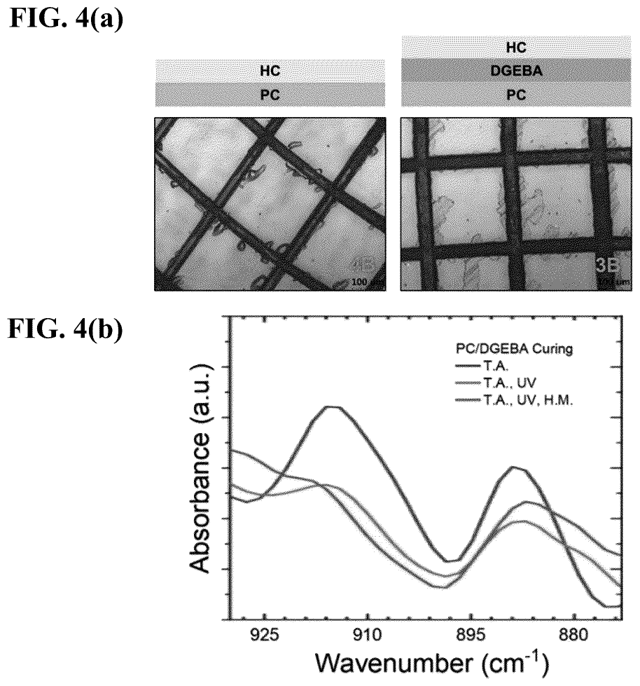

Therefore, in order to determine whether the decrease in pencil hardness was due to low adhesion, a cross-cut adhesion test was performed. The cross-cut adhesion test was conducted using a cross-cut tester (Elcometer 104, UK) according to the guideline of ASTM D3359-17. The cuts were made at 1 mm interval using a cutter to create a grid pattern on the coated surface, and an adhesive tape was applied and then removed. The results were examined under a microscope and shown in FIG. 4(a). The adhesion is classified as follows; 5B—No impact; 4B—Effect area<5%; 3B—Effect area 5-15%; 2B—Effect area 15-35%; 1B—Effect area 35-65%; and OB—Effect area>35%. The adhesion of the PC/HC laminate according to the cross-cut adhesion test was 4B, while the adhesion of the PC/DGEBBA/HC laminate deteriorated to 3B.

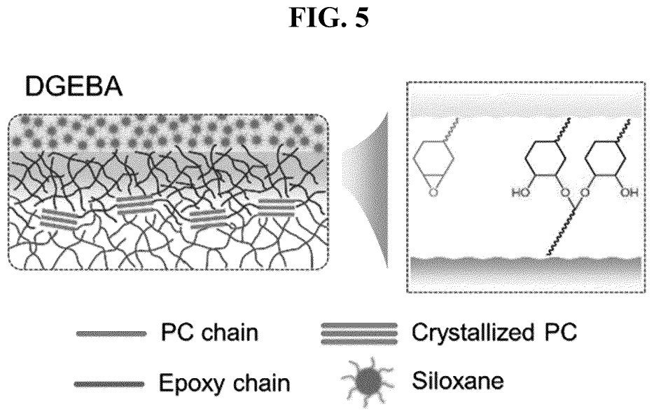

Referring to the Fourier-transform infrared spectroscopy (FTIR, Bruker Vertex 70v) spectra of PC/DGEBA shown in FIG. 4(b), the underlying cause of the decrease in surface hardness and adhesion can be inferred. The epoxy peaks at 915 and 883 cm⁻¹ observed in the PC/DGEBA sample before the formation of the CEOS hard coating layer significantly decreased after photocuring, compared to the samples where the solvent was removed by annealing after coating. This indicates a high level of epoxy conversion in the primer, resulting in reduced epoxy reactivity with the hard coating layer. The decreased reactivity with the hard coating layer is interpreted to cause a decrease in adhesion and surface hardness (refer to FIG. 5).

### (3) PC/MFP/HC Laminate

In order to address the issue of decreased adhesion and surface hardness typically observed in laminates using conventional epoxy primers, a laminate was manufactured using MFP, a new mixture of epoxy resin and CEOS, as a primer, and its properties were evaluated.

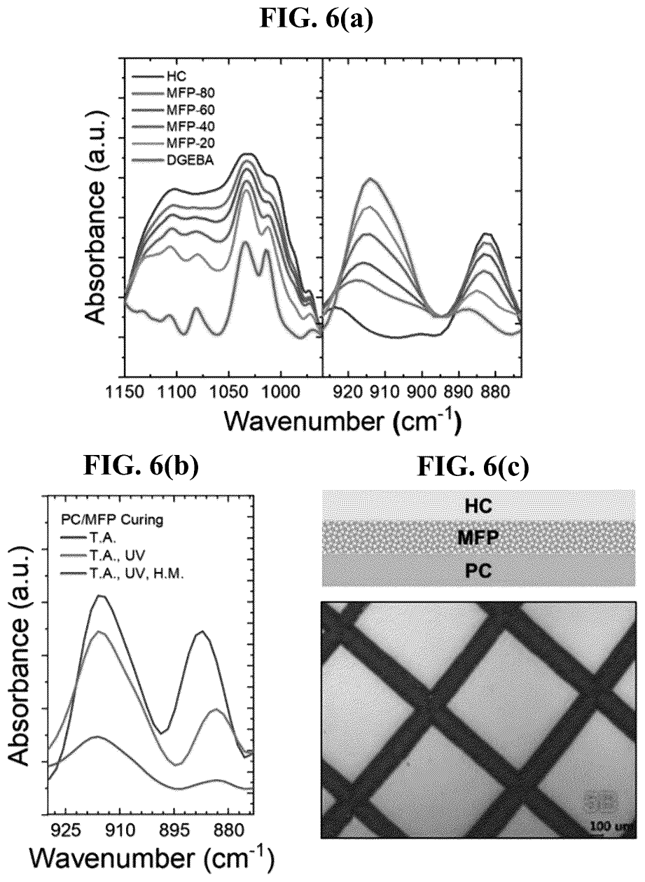

First, it was determined by FTIR whether the aggregation or precipitation occurred during the mixing of DGEBA and CEOS for the preparation of the MFP primer. Visual observation indicated that the DGEBA solution and the CEOS solution were could be mixed uniformly to for a homogeneous mixture. In the FTIR spectra of the MFP solution shown in FIG. 6(a), the peaks corresponding to the epoxy groups at 915 and 883 cm⁻¹ observed in DGEBA and CEOS, respectively, were detected, and the intensity of these peaks depended on the composition ratio. Additionally, the peaks at 1000-1200 cm⁻¹ indicating the presence of siloxane were observed in the MFP solution, similar to those observed in the CEOS solution. These results demonstrate that DGEBA and CEOS form a homogeneous mixture without unwanted reactions.

Subsequently, the absorbance of FTIR spectra was observed at each stage of forming the MFP primer layer on the polycarbonate substrate and is shown in FIG. 6(b). The peaks corresponding to the epoxy groups observed after the annealing process for solvent removal after bar coating of the MFP primer layer indicate that only a portion of the epoxy groups are converted after photocuring, and most of the epoxy group are converted due to the reaction after additional heat-moisture treatment. Therefore, it is anticipated that the formation of the hard coating layer after photocuring will result in a laminate with excellent adhesion and surface hardness due to the reaction between the epoxy groups remaining in the primer layer and the epoxy groups in the hard coating layer. As can be seen from FIG. 6(c), the PC/MFP/HC laminate actually exhibited excellent adhesion of 5B in the cross-cut adhesion test.

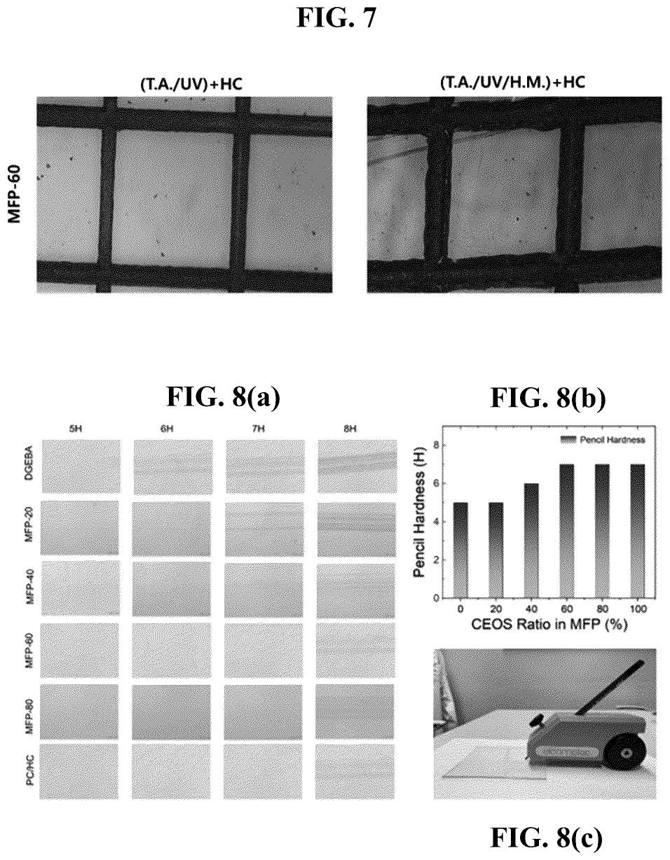

It can be inferred from the above results that the formation of the primer layer would affect the adhesion. Therefore, the differences in adhesion according to the formation of the primer layer were investigated. As predicted in FIG. 6(b), when only the photocuring of the primer layer was formed followed by the formation of the hard coating layer, excellent adhesion was observed; however, when additional heat curing was performed under moist heat conditions after the photocuring, followed by the formation of the hard coating layer, the adhesion was rather decreased (FIG. 7).

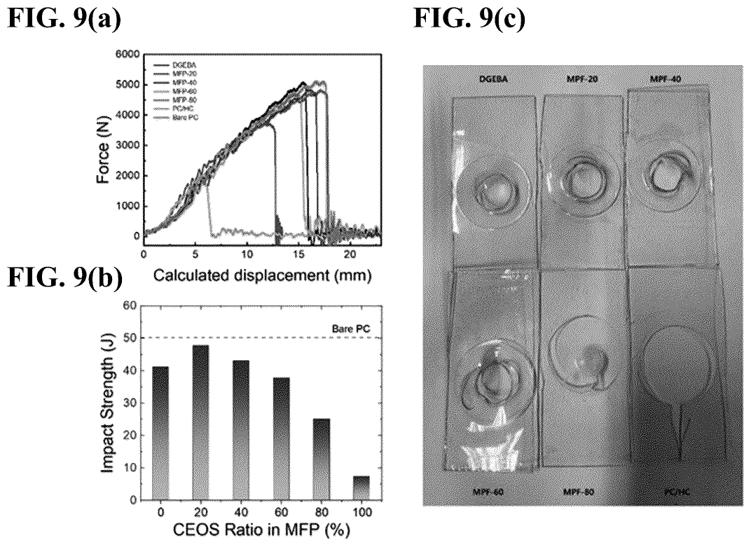

Therefore, the surface hardness and impact strength of the PC/MFP/CEOS laminate according to the CEOS ratio in the MFP composition were measured by the same method as in the above Example, and the results are shown in FIGS. 8 and 9, respectively. As a Comparative Example, in FIGS. 8 and 9, the CEOS ratio of 0 represents the PC/DGEBA/HC laminate using DGEBA as the primer, and the CEOS ratio of 100 represents the PC/HC laminate without a primer layer.

FIG. 8(a) depicts images showing the surface hardness according to the composition of the primer layer, FIG. 8(b) is a graph showing this, and FIG. 8(c) is an image showing the test process according to the ASTM D3363 protocol. The pencil hardness of the laminate ranged from 5H to 7H, depending on the composition of the primer layer. As the CEOS ratio in the primer layer increased, the pencil hardness also increased, and when the CEOS ratio exceeded 60%, pencil hardness remained constant at 7H.

FIG. 9(a) and FIG. 9(b) depict graphs showing the impact strength according to the composition of the primer layer, and FIG. 9(c) is an image of the laminate after the experiment. The impact strength of the laminate decreased as the CEOS ratio increased, and in the case of MFP-20, the pencil hardness significantly increased to 5H, compared to 4B for the polycarbonate substrate, while the impact strength reached a level comparable to that of the polycarbonate substrate. Therefore, by adjusting the ratio of CEOS in the MFP depending on the properties required for specific applications, it is possible to provide a laminate with a desired level of impact strength and surface hardness.

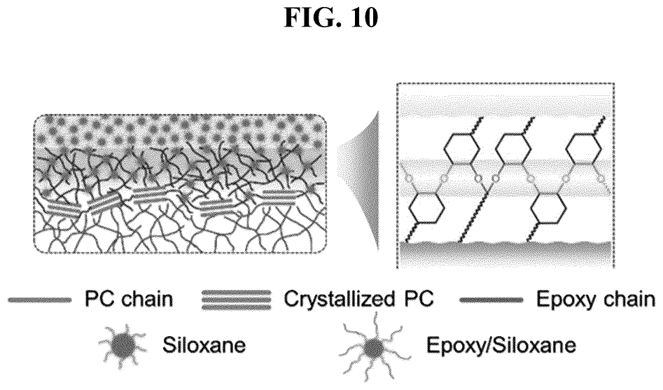

The laminate of the present inventive concept can exhibit high surface hardness and impact strength, and the reason for this can be explained as the siloxane bonds with the epoxy resin in the primer layer and the interfacial bonding with the hard coating layer exhibits excellent adhesion, as shown in FIG. 10.

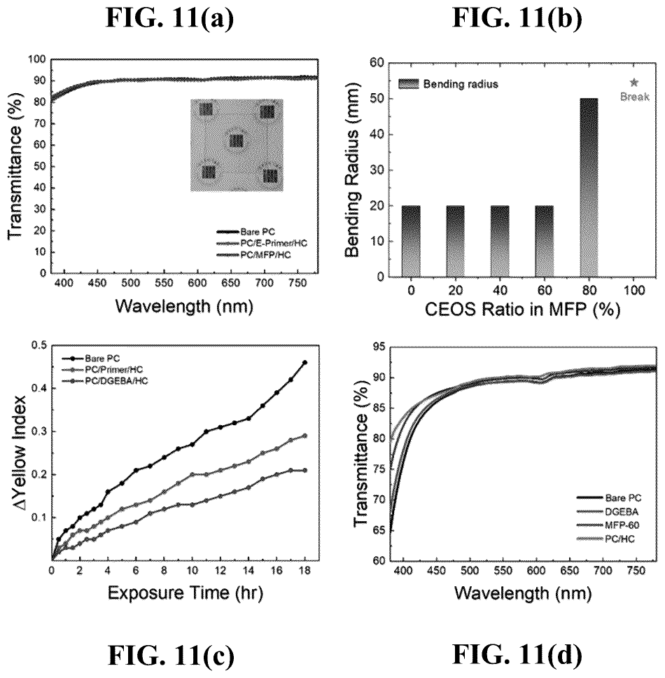

In addition to the surface hardness and impact strength, the optical properties are also required for cover windows, and when applied to curved displays, the cover windows require flexibility to allow curved shaping. Polycarbonate has the property of yellowing when exposed to light, and thus the durability due to UV stability is also an important property. Accordingly, each property was evaluated, the results are shown in FIG. 11(a), FIG. 11(b), FIG. 11(c) and FIG. 11(d), and the measured properties are summarized in Table 1.

The optical properties were evaluated by the average transmittance of 380-780 nm measured from the UV-Vis spectrum within the range of 300-800 nm (FIG. 11(a)) and the haze value measured from a haze meter according to ASTM D1003. Transmittance and haze are important factors in delivering information cleanly and clearly. The polycarbonate substrate itself exhibited a high transmittance of 90.54% and a low haze of 0.23, indicating almost no light scattering. The introduction of the hard coating layer or the primer layer/hard coating layer did not significantly affect the optical transmittance, and the haze value slightly increased, but remained very low, making it suitable for cover windows.

Flexibility was measured by bending the laminate into a U-shape around a cylindrical bar with a diameter of 10 mm to 50 mm and measuring the minimum radius of curvature (½ of the corresponding cylinder diameter) at which the coating layer can be restored to its original state without breaking. Flexibility is a property that affects the production of curved or panoramic displays. The polycarbonate substrate exhibited excellent flexibility with a radius of curvature of 5 mm, while the PC/HC laminate was very vulnerable to bending as the substrate broke even at a radius of curvature of 25 mm. On the contrary, with the introduction of the primer layer, flexibility was greatly improved, demonstrating a radius of curvature of 10 mm.

Polycarbonate is known to have low UV stability, leading to the formation of radicals by UV exposure, followed by the reaction with polymer chains, resulting in decreased molecular weight and yellowing. UV stability refers to weather resistance for performance and visibility, and it is crucial, especially in display cover windows exposed to direct sunlight, such as automotive displays. UV stability was evaluated by exposing the laminate to a 20 W UV-B lamp, positioned 20 cm away according to the ISO 4892-3 test method, for 18 hours, and then measuring the difference in yellowness according to the ASTM D1925 method. FIG. 11(c) shows the differences in yellowness over the duration of UV exposure, and FIG. 11(d) shows the UV-VIS spectra after 18 hours of exposure.

The difference in yellowness (ΔYI) of the polycarbonate substrate was 0.47, indicating a significant change in color. However, with the formation of the siloxane hard coating layer on the PC substrate, ΔYI decreased significantly to 0.16, and the laminate PC/DGEBA/HC with an epoxy primer layer also showed a slightly reduced ΔYI value of 0.32. The PC/MFP/HC laminate demonstrate an intermediate improvement, with a ΔYI value more than more than 50% lower than that of polycarbonate.

TABLE 1

| | | | PC/MFP/HC | | | | PC/DGEBA/ |
|---|---|---|---|---|---|---|---|
| | PC | PC/HC | [symbol] | | | | HC |
| | [symbol] | [symbol] | [symbol] | [symbol] | [symbol] | [symbol] | [symbol] |
| Transmittance (%) | 90.54 | 90.61 | 90.71 | 90.64 | 90.38 | 90.51 | 90.51 |
| Haze (%) | 0.23 | 0.51 | 0.61 | 0.68 | 0.58 | 0.63 | 0.72 |
| Pencil hardness | 4B | 7H | 7H | 7H | 6H | 5H | 5H |
| Radius of curvature | 5 | Break | 50 | 20 | 20 | 20 | 10 |
| (mm) | | | | | | | |
| Adhesion | — | 4B | 5B | 5B | 5B | 4B | 3B |
| Impact strength (J) | 50.425 | 7.461 | 25.186 | 37.798 | 43.002 | 47.873 | 41.135 |
| UV stability (ΔYI) | 0.47 | 0.16 | — | 0.22 | — | — | 0.31 |

Laminate were manufactured using MFP as a primer, a mixture of acrylic-based resin and CEOS, instead of epoxy resin, and their properties were evaluated.

For this purpose, instead of epoxy resin, MFP was manufactured by mixing polyurethane acrylic resin 3052 (ThreeBond) or acrylic resin 3042B (ThreeBond) with CEOS at a weight ratio of 40:60. Using this, PC/MFP/HC laminates were manufactured and their properties were evaluated Table 2 shows the results. Like the epoxy resins, the acrylic-based resins such as polyurethane acrylic resin and acrylic resin also exhibited a decrease in pencil hardness in the PC/primer/HC laminates compared to the PC/HC laminates, and the cause for this was interpreted to be due to a decrease in adhesion. On the contrary, in the case of the PC/MFP/HC laminate, it maintained the pencil hardness equivalent to the PC/HC laminate, while preserving the optical properties.

TABLE 2

| | | Transmittance | | | |
|---|---|---|---|---|---|
| | Structure | (%) | Haze (%) | Pencil hardness | Adhesion |
| | [symbol] | [symbol] | [symbol] | [symbol] | [symbol] |
| 3052 | PC/HC | 90.68 | 0.51 | 7H | 4B |
| (Polyurethane | PC/3053/HC | 90.47 | 0.60 | 4H | 3B |
| acrylate) | PC/MFP/HC | 90.70 | 0.58 | 7H | 5B |
| 3042B | PC/HC | 90.68 | 0.51 | 7H | 4B |
| (Acrylate) | PC/3052B/HC | 90.51 | 0.59 | 5H | 4B |
| | PC/MFP/HC | 90.74 | 0.63 | 7H | 5B |

While the inventive concept has been shown and described with reference to certain preferred embodiments thereof, it will be understood by those skilled in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

What is claimed is:

1. An optical laminate: comprising a polycarbonate/primer layer/hard coating layer, characterized in that:
(A) the hard coating layer is a cured product of a siloxane resin prepared by hydrolytic condensation of an alkoxy silane of the following Formula 1 containing a cycloaliphatic epoxy group; and
(B) the primer layer is a cured product of a mixture of at least one curing resin selected from an acrylic-based resin, a polyurethane-based resin, and an epoxy-based resin, and the siloxane resin:
R¹Si(OR²)₃ [Formula 1]
where R¹ is a linear or branched C₁-C₆ alkyl group containing a cycloaliphatic epoxy group, the cycloaliphatic epoxy group being a C₃-C₆ cycloalkyl group that forms a fused bicycle with an epoxy group, and
R² is a linear or branched C₁-C₆ alkyl group.

2. The optical laminate of claim 1, wherein the primer layer and the hard coating layer chemically bond at an interface.

3. The optical laminate of claim 1, wherein the curable resin comprises at least one selected from the group consisting of an acrylic resin, an epoxy acrylic resin, a polyurethane acrylic resin, a polyether acrylic resin, a cycloaliphatic epoxy resin, and a glycidyl ether-based epoxy resin.

4. The optical laminate of claim 1, wherein R¹ of the alkoxy silane is a 2-(3,4-epoxycyclohexyl)ethyl group or a 2-(3,4-epoxy-3-methylcyclohexyl)ethyl group.

5. The optical laminate of claim 1, wherein the optical laminate has an average transmittance of 90% or more in the range of 380 to 780 nm and a haze of less than 1%.

6. The optical laminate of claim 1, wherein the optical laminate has a pencil hardness of 5H-7H on the hard coating surface and a dart drop impact strength of 20-50 J according to ASTM D3763.

7. The optical laminate of claim 6, wherein the radius of curvature indicating flexibility of the optical laminate ranges from 10 mm to 25 mm.

8. The optical laminate of claim 6, wherein the optical laminate has a difference in yellowness of 0.30 or less after 18 hours of exposure to a 20W UV-B lamp positioned 20 cm away.

9. A method of manufacturing the optical laminate of claim 1, comprising the steps of:
(A) preparing a polycarbonate substrate, at least one curing resin selected from an acrylic-based resin, a polyurethane-based resin, and an epoxy-based resin, and a siloxane resin prepared by hydrolytic condensation of an alkoxy silane of the following Formula 1 containing a cycloaliphatic epoxy group, respectively;
R¹Si(OR²)₃ [Formula 1]
where R¹ is a linear or branched C₁-C₆ alkyl group containing a cycloaliphatic epoxy group, the cycloaliphatic epoxy group being a C₃-C₆ cycloalkyl group that forms a fused bicycle with an epoxy group, and
R² is a linear or branched C₁-C₆ alkyl group;
(B) preparing a primer composition by mixing the siloxane resin and the curable resin at a predetermined ratio;
(C) forming a primer layer by coating the primer composition onto the polycarbonate substrate, followed by curing; and
(D) forming a hard coating layer by coating the hydrolyzed condensate of the alkoxy silane onto the primer layer, followed by curing.

10. The method of manufacturing the optical laminate of claim 9, wherein in step (B), the siloxane resin and the curable resin are mixed at a weight ratio of 20:80 to 80:20.

11. The method of manufacturing the optical laminate of claim 9, wherein the formation of the primer layer in step (C) is achieved by photocuring the primer composition.

12. The method of manufacturing the optical laminate of claim 11, wherein the formation of the hard coating layer in step (D) comprises the steps of:
(a) photocuring the siloxane resin; and
(b) heat-treating the photocured product under a relative humidity condition of 50% or more.

13. The method of manufacturing the optical laminate of claim 11 or 12, further comprising, before the step of photocuring, the step of removing the solvent by heat treatment.

14. A primer composition comprising a mixture of at least one curable resin selected from an acrylic-based resin, a polyurethane-based resin, and an epoxy-based resin, and a siloxane resin prepared by the hydrolytic condensation of the alkoxy silane of the above Formula 1.

15. A cover window for a display comprising the optical laminate of claim 1.

16. The cover window for a display of claim 15, wherein the cover window for a display is used for an automotive display.
